(19) United States
(12) Patent Application Publication
(10) Pub. No.: US 2025/0379741 A1
(43) Pub. Date: Dec. 11, 2025

(54) Techniques for Device Authentication

(71) Applicant: Apple Inc., Cupertino, CA (US)

(72) Inventor: Ara H. Aroyan, Redwood City, CA (US)

(21) Appl. No.: 19/225,517

(22) Filed: Jun. 2, 2025

Related U.S. Application Data
(60) Provisional application No. 63/657,658, filed on Jun. 7, 2024.

(51) Int. Cl. H04L 9/32; H04L 9/08

(52) U.S. Cl. CPC H04L 9/3231; H04L 9/0819

(57) ABSTRACT

Techniques are disclosed relating to user authentication. In some embodiments, a first device includes an authentication system configured to store an identity of a user of the first device and detect a visual indication presented on a display of a second device in response to a successful biometric authentication of a user of the second device. Based on the visual indication, the authentication system determines that the authenticated user of the second device corresponds to the identity of the user of the first device. In some embodiments, the second device includes a display with a lenticular lens and, in response the user has been authenticated, displays a plurality of visual indications including a first visual indication visible from a first viewing angle and a second visual indication visible from a second viewing angle.

The present application claims priority to U.S. Prov. Appl. No. 63/657,658, entitled “Techniques For Device Authentication,” filed Jun. 7, 2024, which is incorporated by reference herein in its entirety.

### BACKGROUND

### Technical Field

This disclosure relates generally to user authentication, and, more specifically, to authenticating a user on a first device via a second device.

### Description of the Related Art

User authentication typically relies on a user providing one or more credentials attesting to the user's identity. For example, a user attempting to log into a device may supply a password before being permitted access to the device. In an effort to reduce the burden on a user, some devices may support authenticating a user via biometric data captured from the user. For example, a mobile device may include a fingerprint sensor configured to collect fingerprint biometric data, which may be compared with stored fingerprint information of a known user. Being able to supply authentication information other than typing in a password, for example, may be advantageous as it allows a user to authenticate more quickly and seamlessly.

### BRIEF DESCRIPTION OF THE DRAWINGS

FIG. 1 is a block diagram illustrating one embodiment of a first computing device authenticating a user using a second computing device.

FIG. 2 is a block diagram illustrating one embodiment of a first computing device sending a request to a second computing device to authenticate a user.

FIG. 3 is a block diagram illustrating one embodiment of the second computing device providing an indication to the first computing device.

FIG. 4 is a block diagram illustrating one embodiment of an authentication using a lenticular lens.

FIGS. 5-7 are flow diagrams illustrating embodiments of methods performed by devices described herein.

FIG. 8 is a block diagram illustrating one embodiment of an exemplary computer system, which may implement techniques described herein.

### DETAILED DESCRIPTION

As a user interacts with a computing device, the computing device may authenticate the user as part of providing access to services, applications, and data. For example, the computing device may verify a user's identity prior to sharing confidential credentials during a transaction. As an added level of security, the computing device may support authenticating a user via biometric data captured from the user with one or more biometric sensors. For example, the computing device may include a camera configured to capture the facial features of a user. A biometric authentication system, however, may fail if the biometrics of a user are obscured by an obstruction, such as a mask, glasses, facial hair, etc. For example, the iris of a user is obstructed when the user is wearing glasses, and accordingly, the user needs to remove the glasses in order for the biosensor to capture the biometric data required to authenticate the user. As a result, the user may not be able to access services, applications, and data. Additionally, multiple failed authentication attempts may cause the computing device to be disabled for a set period of time. In other cases, a computing device may lack the ability to authenticate the user. For example, the computing device may not be configured with a biometric sensor. As such, it may be desirable to authenticate a user on a first computing device by receiving an indication that the user has been authenticated from a biometric authentication system configured on a second computing device.

The present disclosure describes embodiments in which a first device receives an indication that a user has been authenticated via a second device, and based on the indication, the user is authenticated on the first device. As will be described below in various embodiments, the first and second device may include a biosensor configured to collect biometric data from a user and an authentication system configured to perform a user authentication based on the collected biometric data. In response to the biometric authentication being unsuccessful due to an issue, such as an obstruction, the first device broadcasts an authentication request over a communication medium. If the authentication request is received by a second device that has previously performed a successful biometric authentication of the user, the second device generates an indication and provides it to the first device. In some embodiments, the indication is a visual and/or audio indication that encodes the identity of the user and is unique to a given exchange between the first and second device. After receiving the indication, the first device authenticates the user based on the indication.

In many instances, authenticating a user via a second device may greatly improve the user experience as the user is not required to remove the obstruction when performing the user authentication on the first device.

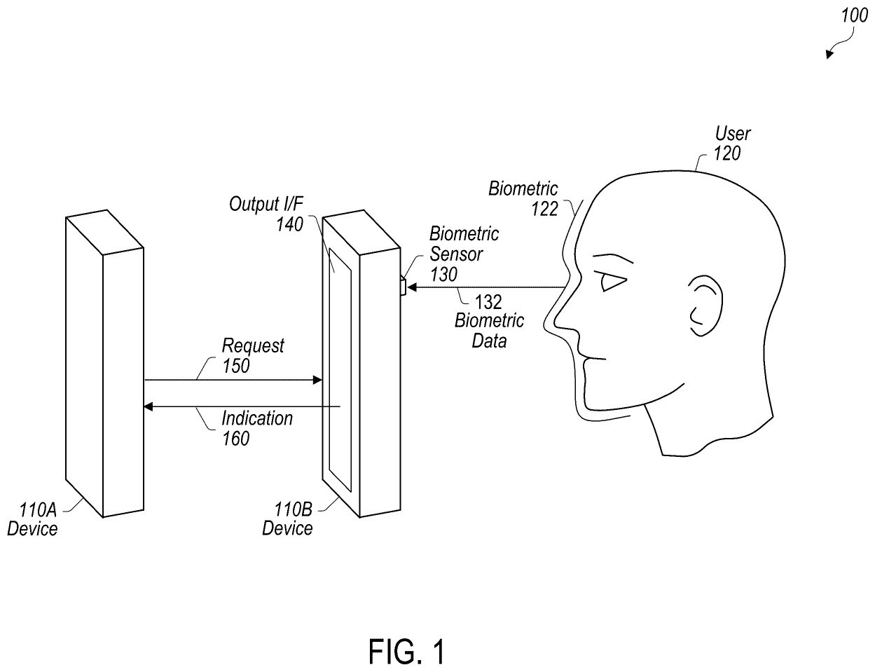

Turning now to FIG. 1, a block diagram of system 100 is shown. System 100 includes a set of components that may be implemented via hardware or a combination of hardware and software routines. In the illustrated embodiment, system 100 includes device 110A and 110B and user 120. As shown, device 110B is configured with biometric sensor 130 and output interface (I/F) 140. In some embodiments, system 100 is implemented differently than shown. For example, device 110B may provide an indication 160 to device 110A without receiving request 150.

Device 110 may correspond to any suitable device that employs user authentication. In some embodiments, device 110 is a mobile device such as a mobile phone, tablet computer, handheld computer, music player, laptop or notebook computer, personal data assistant (PDA), consumer device, etc. In some embodiments, device 110 is an internet of things (IoT) device, server system, desktop computer, mainframe computer system, workstation, network computer, etc. In some embodiments discussed below, device 110 is a wearable device such as a watch, athletic sensor, or a head mounted display, which may be a headset, helmet, goggles, glasses, a phone inserted into an enclosure, etc. In some embodiments, device 110 is a vehicle such as an aircraft, marine vessels, recreational vehicles (RVs), automobiles, buses, railed vehicles, spacecraft, robotic devices, trucks, trailers, cranes, caterpillars, etc.

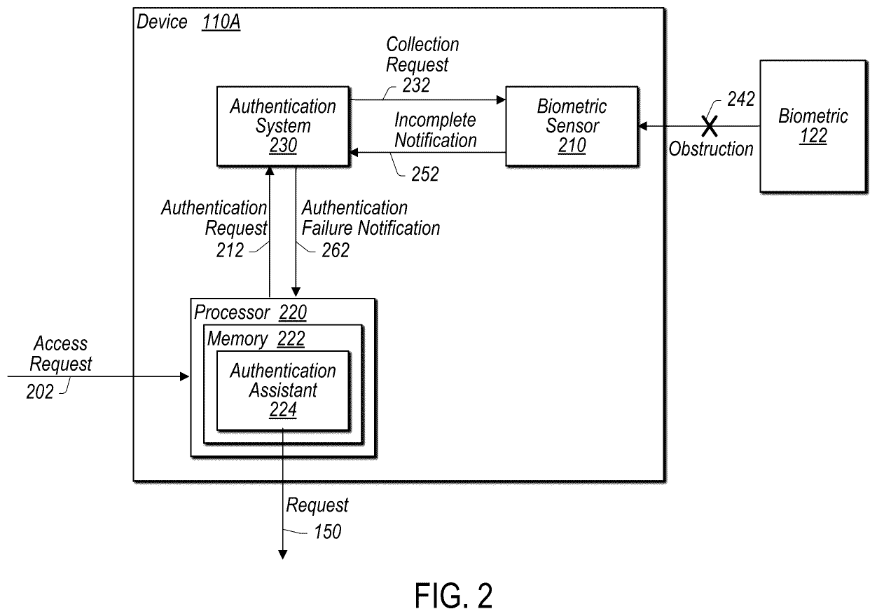

As user 120 interacts with device 110A, user 120 may initiate an authentication process by attempting to access device 110A and/or an application, service, and data provided by device 110A. For example, user 120 may attempt to access a locked device 110A by interacting with the device's user interface. As a result, an access request is created and provided to an authentication system configured on device 110A to perform a user authentication. In some cases, the authentication system of device 110A may fail to authenticate user 120. For example, a biometric sensor of device 110A may be obstructed such that device 110A is unable to detect a user biometric 122 of user 120, resulting in a failed authentication attempt. In response to a failed authentication attempt, device 110A generates and sends request 150 to device 110B. Request 150, in various embodiments, is a request to receive an indication 160 (e.g., confirmation) that the user has been authenticated via an authentication system configured on device 110B. Device 110A and request 150 are discussed in greater detail with respect to FIG. 2.

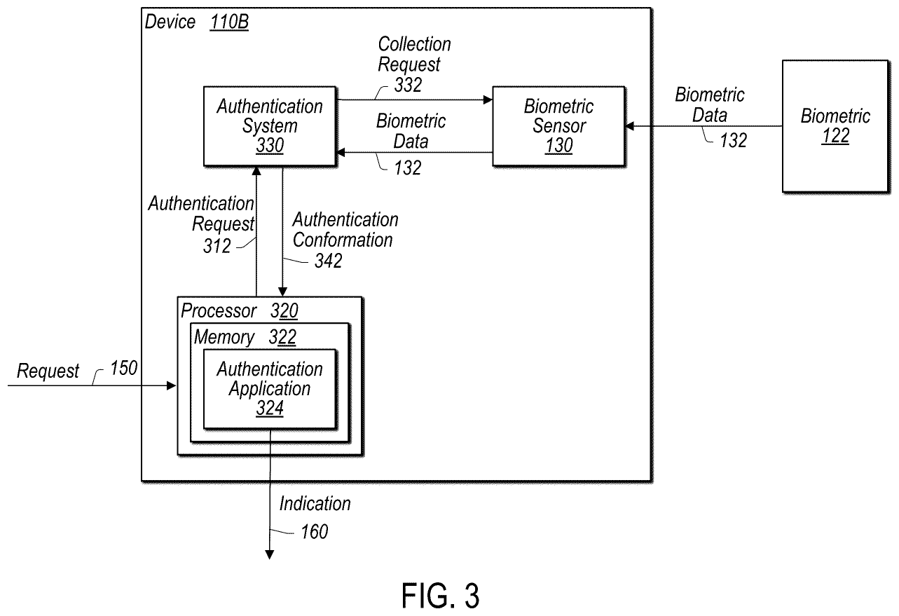

In the illustrated embodiment, device 110B is configured to perform a biometric authentication, using biometric sensor 130, to authenticate user 120. A biometric sensor 130, in various embodiments, includes one or more sensors used to collect biometric data 132 describing the biometrics 122 from user 120. Biometric 122 refers to the unique physical and/or behavioral characteristics of user 120, such as the iris, retina, voice, facial structure, and/or fingerprints of user 120. Biometric data 132 refers to data points, such as measurements, collected from the biometrics 122 of user 120 via the biometric sensor 130. For example, biometric data 132 may by captured by a camera and include measurements and/or calculations that map the shape of the user's face, such as the position of the eyes, nose, and mouth. Device 110B may compare biometric data 132 to stored biometric information in order to authenticate user 120. Device 110B is discussed in greater detail with respect to FIG. 3.

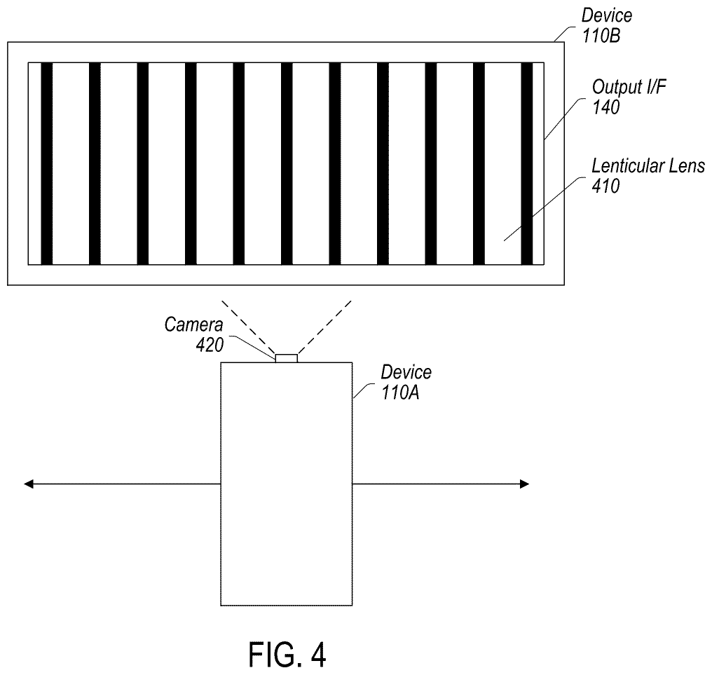

In response to receiving request 150, device 110B provides an indication 160 to device 110A via output I/F 140. Indication 160, in various embodiments, is a visual and/or audio indication that the user has been authenticated via biometric sensor 130 and an authentication system configured on device 110B. For example, device 110B may display an image, using output I/F 140, that indicates user 120 has been authenticated. Indication 160 is discussed in greater detail with respect to FIG. 3. Output I/F 140, in various embodiments, is a display, a speaker, a haptic engine, etc. Output I/F 140 is discussed in greater detail with respect to FIG. 4. After receiving indication 160 from device 110B, device 110A grants access to user 120.

Turning now to FIG. 2, a block diagram of a portion of device 110A is shown. In the illustrated embodiment, device 110A includes a biometric sensor 210, a processor 220 with memory 222, and an authentication system 230. As further illustrated, memory 222 includes an authentication assistant 224. In some embodiments, device 110A may be implemented differently than shown. For example, device 110A may not be configured with biometric sensor 210.

In the illustrated embodiment, device 110A receives an access request 202 from user 120. An access request 202, in various embodiments, is a request to access device 110A and/or an application, service, and/or data provided by device 110A. For example, user 120 may attempt to access an application that requires user 120 to verify their identity. As part of authenticating user 120, device 110A sends an authentication request 212 to authentication system 230.

Authentication system 230 is a system configured to determine whether a user of device 110A is an authorized user by performing a biometric authentication via a biosensor 210. Authentication system 230 is implemented using circuitry, a memory having program instructions stored therein, or a combination thereof. As shown, authentication system 230 receives authentication request 212 from processor 220A that requests authentication system 230 to authenticate user 120. Accordingly, authenticate user 120 provides corresponding authentication responses (e.g., authentication failure notification 262) based on the results of the authentication. Authentication request 212 may originate from any of various sources within device 110A, such as an operating system, applications executing on device 110A, secured peripherals, etc. and, in some embodiments, may be received via an application programming interface supported by system 230. Authentication request 212 may also be issued for any of various operations/actions, such as unlocking/logging into device 110A, opening particular applications, accessing confidential/secured information (e.g., stored authentication credentials, encrypted files, payment credentials, etc.), performing tasks with elevated privileges, etc. For example, if user 120 is requesting access to an encrypted file/data, authentication system 230 may attempt to confirm that user 120 is authentic prior to providing access. In response to receiving authentication request 212, authentication system 230 sends a collection request 232 to biometric sensor 210.

Biometric sensor 210 includes one or more sensors configured to collect biometric data from a user. As used herein, “biometric data” refers to data that uniquely identifies user 120 relative to other users (at least to a high degree of accuracy) based on the user's 120 physical or behavioral characteristics. In some embodiments, biometric sensor 210 is a camera configured to collect facial data of a user's face in order to perform facial recognition. For example, biometric sensor 210 may include a camera configured to collect images of a user's eyes in order to perform iris recognition. In still other embodiments, biosensor 210 may be configured to collect other forms of biometric data such as iris data, retina data, voice recognition data, fingerprint data, vein data, etc. In other embodiments, device 110A may not include biometric sensor 210 and is configured to support other forms of authentication. For example, authentication system 230 may be configured to authenticate a user based on a supplied secret known to an authorized user such as password, passcode, personal identification number (PIN), token, security questions, etc. Authentication system 230 may also support authentication using public-key cryptography, which may include a challenge response exchange with a key presented by a user.

In the illustrated embodiment, biometric sensor 210 is unable to collect biometric data 132 from user 120 due to the presence of an obstruction 242. In some embodiments, an obstruction 242 is a physical item that obscures the biometrics 122 of user 120. For example, device 110A may attempt to collect images of a face or an iris via a camera but is obstructed by a head mounted display, which may be worn by user 120 and corresponds to device 110B. In some embodiments, an obstruction 242 is a software issue and/or permissions that prevents biometric sensor 210 from collecting biometrics 122 of user 120. For example, an application may not have permission to access the camera of device 110A to verify the identity of user 120. Because biometric sensor 210 is unable to collect biometrics 122 from user 120, it notifies authentication system 239 via an incomplete notification 252.

In response to receiving an incomplete notification 252, authentication system 230 sends an authentication failure notification 262 to processor 220A. Processor 220A fetches a set of software instructions from memory 222A executable to generate request 150. Request 150, in various embodiments, is a request to receive an indication 160 that user 120 has been authenticated and is broadcast via a network interface. The network interface may support any suitable wireless communication technology such as Wi-Fi®, Bluetooth®, Near Field Communication (NFC), etc. or any suitable wired communication technology such as Ethernet, Fibre Channel, etc. In some embodiments, request 150 may be sent directly to a particular device 110 within a distance threshold (e.g., radius) from requesting device 110A. For example, a smartphone may send request 150 directly to a device located within the same room. Device 110A may determine that device 110B is within the distance threshold based on signal strength (e.g., Bluetooth), ultra-wideband (UWB), global positioning system (GPS), cell tower triangulation, etc. For example, device 110A may broadcast a UWB signal to locate and pair to a nearby device 110. In some embodiments, prior to sending request 150, device 110A may enable a camera on device 100A to capture an image of the obstruction 242 to confirm that one is present before sending request 150. Device 110A may, for example, use image recognition to identify device 110B in order to confirm that device 110B is within the distance threshold, a user is wearing device 110B if device 110B is an HMD. Device 110A may also use a camera to identify device 110B within its field of view and/or evaluate other criteria before sending out request 150.

In some embodiments, request 150 may include a user account associated with device 120A. For example, request 150 may include user's 120 personal data and settings that indicate that user 120 is the owner of device 110A. Request 150 may be sent directly to other devices 110 associated with the user account. For example, the user account may be associated with a smartphone, tablet, and head mounted display, and accordingly, request 150 may be sent directly from the smartphone to the tablet and watch. In other embodiments, user 120 may select a particular device from a list of devices 110 using an interface, and as a result, device 110A sends request to the selected device 110. For example, user 120 may select a particular device 110, because user 120 has already successfully authenticated their identity via the particular device 110. In some embodiments, request 150 includes other information that can be used by device 110B in determining how (and whether) to respond to request 150. For example, request 150 may include information that describes the environment of device 110A such as an image captured by a camera of device 110B, a description of objects (or the obstruction) within the environment that can be used to verify the user is making a legitimate request, etc.

Turning now to FIG. 3, a block diagram of a portion of device 110B is shown. In the illustrated embodiment, device 110B includes a processor 220B, an authentication system 330, and a biometric sensor 130. As further depicted, processor 220B includes memory 222B and authentication application 310. In some embodiments, device 110B may be implemented differently than shown.

In the illustrated embodiment, authentication application 324 receives request 150 to provide an indication 160 that user 120 has been authenticated via authentication system 330. Authentication application 324 may extract information from request 150, such as user identity information, prior to sending authentication request 312. For example, authentication application 324 may compare the user account associated with request 150 to the user account associated with device 110B. Accordingly, application 324 may send authentication request 312 based on the results of the comparison.

In the illustrated embodiment, authentication request 312 is sent to authentication system 330. Authentication request 312, in various embodiments, request authentication system 330 to authenticate user 120. Authentication request 312 may include information extracted from request 150 that is used by authentication system 330 to authenticate user 120. Authentication system 330 is a system configured to determine whether the user of device 110B is an authorized user by performing a biometric authentication via biosensor 130. In some embodiments, authentication system 330 and 230 may implement similar functionalities. In response to receiving authentication request 312, authentication system 330 sends a collection request 332 to biometric sensor 130.

Biometric sensor 130 includes one or more sensors configured to collect biometric data 132 from biometric 122 of user 120. In some embodiments, biometric sensors 130 and 210 may implement similar functionalities. As shown, the collected biometric data 132 is provided to authentication system 330. Authentication system 230, in various embodiments, compares the biometric data 132 collected from user 120 to stored biometric data of an authorized user in order to determine whether user 120 is authentic. In some embodiments, authentication system 330 compares the biometric data 132 to biometric data extracted from request 150. For example, request 150 may include stored biometric data 132 from device 110A. After authenticating the user, authentication system 330 sends authentication confirmation 342 to authentication application 324.

Authentication application 310, in various embodiments, is configured to generate indication 160 based on authentication confirmation 342. In some embodiments, user 120 may be authenticated by authentication system 330 prior to receiving request 150. As a result, authentication application 324 may generate indication 160 based on an existing authentication confirmation 342.

Indication 160 is a confirmation that user 120 has been authenticated via authentication system 330 and can be represented as a visual and/or audio indication. Visual indication 160, in various embodiments, is an image that encodes an authentication confirmation and/or data associated with the identity of user 120 (e.g., username) and is displayed using output I/F 140. For example, indication 160 may indicate that user 120 has been authenticated via authentication system 330 and is displayed on a forward-facing display of a head-mounted display. Visual indication 160 may be a pattern arranged in a grid of varying shapes and includes one or more colors. Visual indication 160 may be static in which the pattern and/or shape does not change or move. For example, visual indication 160 may be a two-dimensional grid-like pattern that includes a plurality of colors. Visual indication 160 may be dynamic in which the pattern and/or shape is changing or amorphous. For example, the image may be a series of moving lines and colors displayed by the responding device 110B. Indication 160 may be unique to a given exchange between device 110A and 110B.

In some embodiments, a cryptographic key is encoded in visual indication 160 to encrypt data exchanged between devices 110. For example, this cryptographic key may include an advanced encryption standard (AES) key used by device 110A to establish a secure communication with device 110B. This cryptographic key may also be used as key material input into a key derivation function (KDF) to derive one or more cryptograph keys used secure communication between devices 110. In some embodiments, the cryptographic key is a public key of device 110B, which may be used to establish a shared key via an elliptic-curve Diffie-Hellman (ECDH), for example.

In some embodiments, indication 160 can also include a sound performed by device 110B that indicates that user 120 has been successfully authenticated by authentication system 330. Audio indication 160 may include a singular audio cue (e.g., beep, chime, click, etc.), a series of audio cues, or a combination of audio cues. Indication 160 may include sounds with varying frequencies and sound durations, and it may be audible or inaudible. In various embodiments, indication 160 may include an audio indication performed at least partially in parallel with a visual indication. In some embodiments, indication 160 is used to indicate that user 120 has not be successfully verified by authentication system 330.

In some embodiments, indication 160 encodes information about biometric data 132 collected via biometric sensor 130. Authentication system 230 on device 110A may compare the received biometric data 132 to biometric data stored on device 110A to authenticate user 120. For example, device 110B may capture biometric data 132 describing the iris of user 120 and provide the captured biometric data 132 in indication 160. Accordingly, authentication system 230 may compare the iris data received from device 110B to stored iris data on device 110A. Based on the result, device 110A may determine to provide access to user 120.

Turning now to FIG. 4, a block diagram of an authentication using a lenticular lens is shown. In the illustrated embodiment, device 110B includes output I/F 140 with a lenticular lens 410. As further depicted, device 110A includes a camera 430 for capturing indication 160. In some embodiments, device 110B may be implemented differently than shown.

In the illustrated embodiments, output I/F 140 is configured to display visual indication 160 via a lenticular lens 410. Lenticular lens 410, in various embodiments, is an array of lenses that are designed to display segments of visual indication 160 based on the viewing angle and/or distance. For example, output I/F 140 may display a segment of visual indication 160 at a particular angle and display a different segment of visual indication 160 at a different angle. Visual indication 160 may include two or more interlaced images such that each image is displayed based on the viewing angle and/or distance. For example, output I/F 140 may display one image at a particular angle and a second image at a different angle. Each image may encode different information such that the two or more images collectively represent visual indication 160.

In the illustrated embodiment, device 110A is configured with camera 420 to capture visual indication 160. Device 110A may be positioned at different angles, as indicated by the arrows, in order to capture visual indication 160. In some embodiments, capturing visual indication 160 includes taking two or more pictures at two or more angles using camera 420. For example, camera 420 may be positioned at a 45-degree angle to the left of output I/F 140 to capture a first image, positioned at a 45-degree angle to the right of output I/F 140 to capture a second image, and positioned directly in front of output I/F 140 to capture a third image. Accordingly, the three captured images collectively represent visual indication 160. In some embodiments, capturing visual indication 160 includes recording a video while camera 420 pans across lenticular lens 410. Authentication system 230 may analyze a set of frames from the video to extract verification and/or user information from indication 160. Based on the information extracted from indication 160, device 110A may determine to grant access to user 120.

In some embodiments, device 110A determines whether the source (e.g., device 110B) of indication 160 is within a distance threshold prior to authenticating user 120. Device 110A may determine the distance of device 110B based on signal strength (e.g., Bluetooth), ultra-wideband (UWB), global positioning system (GPS), cell tower triangulation, etc. For example, device 110A may receive indication 160 but determine that device 110B is not within the predefined threshold based on device 110B's signal strength. As a result, device 110A may determine to not authenticate user 120.

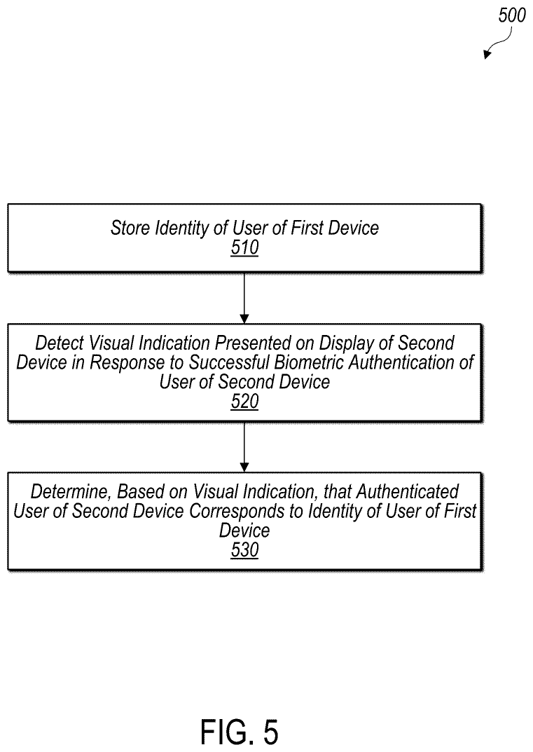

Turning now to FIG. 5, a flow diagram of method 500 is shown. Method 500 is one embodiment of a method that is performed by a first device (e.g., device 110A) to authenticate a user based on performing a biometric authentication on a second device (e.g., device 110B). Method 500 may be performed by executing a set of program instructions stored on a non-transitory computer-readable medium. Method 500 may include more or less steps than shown.

Method 500 begins in step 510 with the authentication system (e.g., authentication system 230) of the first device storing an identity of a user of the first device. In step 520, the authentication system detects a visual indication (e.g., indication 160) presented on a display (e.g., output I/F 140) of a second device in response to a successful biometric authentication (e.g., authentication system 330) of a user (e.g., user 120) of the second device. In various embodiments, the authentication system determines an identity of the authenticated user encoded in the visual indication. In various embodiments, the authentication system determines a cryptographic key encoded in the visual indication and establishes a secure communication with the second device using the cryptographic key. In various embodiments, the authentication system determines a type of authentication encoded in the visual indication. The type may include one of capturing an iris of the user, a retina of the user, a facial structure of the user, or a fingerprint of the user (e.g., biometric 122). In various embodiments, the authentication system validates the visual indication including determining that the visual indication is dynamic such that the visual indication changes while it is presented. In various embodiments, the visual indication is unique to a given exchange between the first device and the second device. A camera (e.g., camera 420) may capture the visual indication on a forward-facing display on the second device.

In step 530, the authentication system of the first device determines, based on the visual indication, that the authenticated user of the second device corresponds to the identity of the user of the first device. In various embodiments, the authentication system determines, from the visual indication, a user account associated with the second device. The authentication system may compare a user account associated with the first device to the user account associated with the second device. Based on the comparison, the authentication system may determine that the user account associated with the first device corresponds to the user account associated with the second device. Based on the determining, the authentication system may permit the user to log into the first device. Based on the determining, the authentication system may permit communication of a user credential from the first device to an external system.

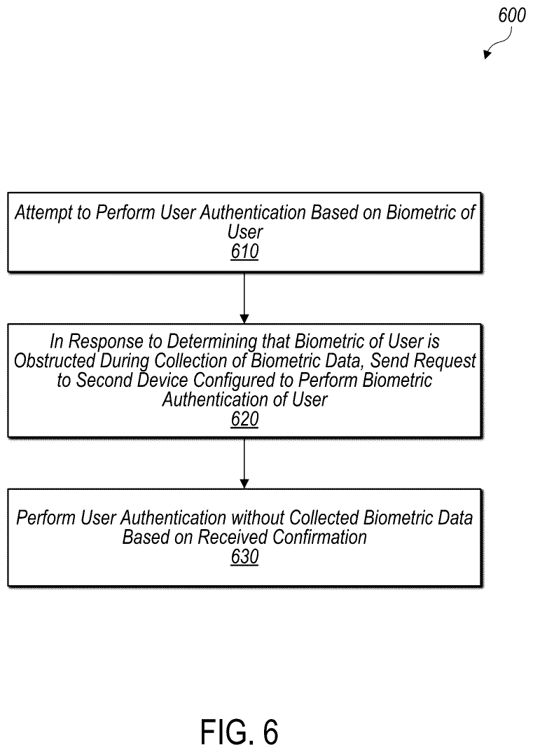

Turning now to FIG. 6, a flow diagram of method 600 is shown. Method 600 is one embodiment of a method that is performed by a first device (e.g., device 110A) to authenticate a user based on performing a biometric authentication on a second device (e.g., device 110B). Method 600 may be performed by executing a set of program instructions stored on a non-transitory computer-readable medium. Method 600 may include more or less steps than shown.

Method 600 begins in step 610 with the authentication system (e.g., authentication system 230) of the first device attempting to perform a user authentication based on the biometric (e.g., biometric 122) of the user (e.g., user 120). In step 620, in response to determining that the biometric of the user is obstructed (e.g., obstruction 242) during collection of the biometric data, the authentication system sends a request (e.g., request 150) to a second device configured to perform a biometric authentication (e.g., authentication system 330) of the user. In various embodiments, the request asks for a confirmation that the user has been authenticated. The authentication system may send the request over a first communication medium and receive the confirmation over a second, different communication medium. The confirmation may be a visual indication (e.g., indication 160). Sending the request may cause the visual indication to be displayed by the second device (e.g., output I/F 140). The confirmation may encode an identity of the authenticated user. The confirmation may be an audio indication, and sending the request may cause the audio indication to be performed by the second device. In various embodiments, the request specifies a user account associated with the device. The request may cause the second device to compare the user account to a user account associated with the second device. The authentication system may provide the confirmation in response to the comparison indicating a match. In step 630, the authentication system performs the user authentication without the collected biometric data based on the received confirmation.

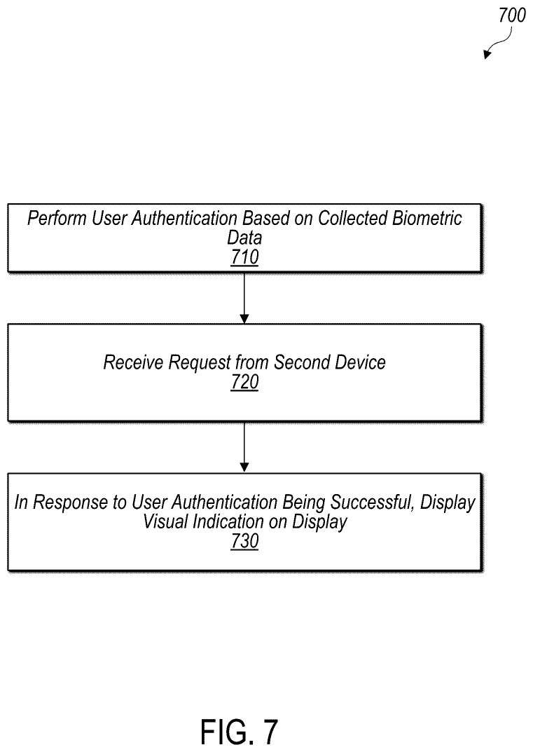

Turning now to FIG. 7, a flow diagram of method 700 is shown. Method 700 is one embodiment of a method that is performed by a first device (e.g., device 110B) to display an indication in response to authenticating a user based on performing a biometric authentication. Method 600 may be performed by executing a set of program instructions stored on a non-transitory computer-readable medium. Method 600 may include more or less steps than shown.

Method 700 begins in step 710 with the authentication system (e.g., authentication system 330) of the first device performing a user authentication based on the collected biometric data (e.g., biometric data 132). In step 720, the authentication system receives a request (e.g., request 150) from a second device. The request may ask for a confirmation (e.g., indication 160) that a user has been authenticated.

In step 730, in response to the user authentication being successful, the authentication system displays a visual indication on a display (e.g., output I/F 140). The visual indication may encode a username associated with the user. In various embodiments, the request specifies a user account associated with the second device. The authentication system may compare the user account to a user account associated with the first device and display the visual indication in response to the comparison indicating a match. In various embodiments, the authentication system generates a cryptographic key to establish a secure communication with the second device and embed the cryptographic key in the visual indication. In various embodiments, the first device includes a display with a lenticular lens (e.g., lenticular lens 410). In response to the user authentication being successful, the display, in various embodiments, is configured to display a plurality of visual indications including a first visual indication visible from a first viewing angle and a second visual indication visible from a second viewing angle.

### Exemplary Computer System

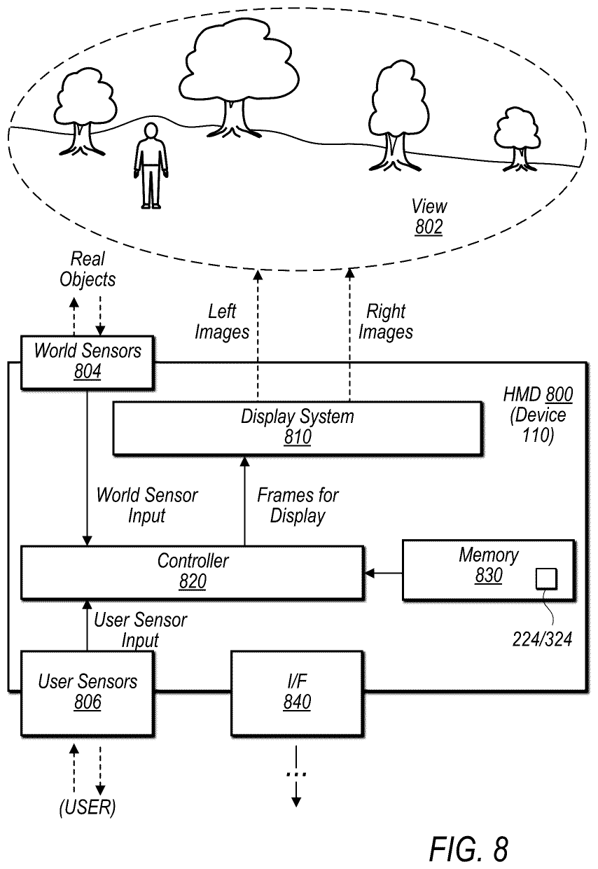

Turning now to FIG. 8, a block diagram of components within a computing device 800, which may implement functionality of one or more of device 110, is depicted. In the illustrated embodiment, computing device 800 is depicted as a head-mounted display (HMD) configured to be worn on the head and to display content, such as an view 802, to a user. For example, HMD 800 may be a headset, helmet, goggles, glasses, a phone inserted into an enclosure, etc. worn by a user. Computing device 800, however, may correspond to other devices in other embodiments, which may (or may not) be presenting content. In the illustrated embodiment, HMD 800 includes world sensors 804, user sensors 806, a display system 810, controller 820, memory 830, and a network interface 840. In some embodiments, HMD 800 may be implemented differently than shown. For example, HMD 800 may include multiple interfaces 840, controller 820 may be implemented using multiple processors, etc.

World sensors 804 are sensors configured to collect various information about the environment in which a user wears HMD 800. In some embodiments, world sensors 804 may include one or more visible-light cameras that capture video information of the user's environment. This information also may, for example, be used to provide a view 802 (which may be an extended reality (XR) view of the real environment), detect objects and surfaces in the environment, provide depth information for objects and surfaces in the real environment, provide position (e.g., location and orientation) and motion (e.g., direction and velocity) information for the user in the real environment, etc. In some embodiments, HMD 800 may include left and right cameras located on a front surface of the HMD 800 at positions that are substantially in front of each of the user's eyes. In other embodiments, more or fewer cameras may be used in HMD 800 and may be positioned at other locations.

In some embodiments, world sensors 804 may include one or more world mapping sensors (e.g., infrared (IR) sensors with an IR illumination source, or Light Detection and Ranging (LIDAR) emitters and receivers/detectors) that, for example, capture depth or range information for objects and surfaces in the user's environment. This range information may, for example, be used in conjunction with frames captured by cameras to detect and recognize objects and surfaces in the real-world environment, and to determine locations, distances, and velocities of the objects and surfaces with respect to the user's current position and motion. The range information may also be used in positioning virtual representations of real-world objects to be composited into an XR environment at correct depths. In some embodiments, the range information may be used in detecting the possibility of collisions with real-world objects and surfaces to redirect a user's walking. In some embodiments, world sensors 804 may include one or more light sensors (e.g., on the front and top of HMD 800) that capture lighting information (e.g., direction, color, and intensity) in the user's physical environment. This information, for example, may be used to alter the brightness and/or the color of the display system in HMD 800.

User sensors 806 are sensors configured to collect various information about a user wearing HMD 800. In some embodiments, user sensors 806 may include one or more head pose sensors (e.g., IR or RGB cameras) that may capture information about the position and/or motion of the user and/or the user's head. The information collected by head pose sensors may, for example, be used in determining how to render and display views 802 of the XR environment and content within the views. For example, different views 802 of the environment may be rendered based at least in part on the position of the user's head, whether the user is currently walking through the environment, and so on. As another example, the augmented position and/or motion information may be used to composite virtual content into the scene in a fixed position relative to the background view of the environment. In some embodiments there may be two head pose sensors located on a front or top surface of the HMD 800; however, in other embodiments, more (or fewer) head-pose sensors may be used and may be positioned at other locations.

In some embodiments, user sensors 806 may include one or more eye tracking sensors (e.g., IR cameras with an IR illumination source) that may be used to track position and movement of the user's eyes. In some embodiments, the information collected by the eye tracking sensors may be used to adjust the rendering of images to be displayed, and/or to adjust the display of the images by the display system of the HMD 800, based on the direction and angle at which the user's eyes are looking. In some embodiments, one or more of these eye tracking sensors may be used to implement a biosensor for biometrically authenticating a user. In some embodiments, the information collected by the eye tracking sensors may be used to match direction of the eyes of an avatar of the user to the direction of the user's eyes. In some embodiments, brightness of the displayed images may be modulated based on the user's pupil dilation as determined by the eye tracking sensors. In some embodiments, user sensors 806 may include one or more eyebrow sensors (e.g., IR cameras with IR illumination) that track expressions of the user's eyebrows/forehead. In some embodiments, user sensors 806 may include one or more lower jaw tracking sensors (e.g., IR cameras with IR illumination) that track expressions of the user's mouth/jaw. For example, in some embodiments, expressions of the brow, mouth, jaw, and eyes captured by sensors 806 may be used to simulate expressions on an avatar of the user in a co-presence experience and/or to selectively render and composite virtual content for viewing by the user based at least in part on the user's reactions to the content displayed by HMD 800.

In some embodiments, user sensors 806 may include one or more hand sensors (e.g., IR cameras with IR illumination) that track position, movement, and gestures of the user's hands, fingers, and/or arms. For example, in some embodiments, detected position, movement, and gestures of the user's hands, fingers, and/or arms may be used to simulate movement of the hands, fingers, and/or arms of an avatar of the user in a co-presence experience. As another example, the user's detected hand and finger gestures may be used to determine interactions of the user with virtual content in a virtual space, including but not limited to gestures that manipulate virtual objects, gestures that interact with virtual user interface elements displayed in the virtual space, etc.

Display system 810 is configured to display rendered frames to a user. Display 810 may implement any of various types of display technologies. For example, as discussed above, display system 810 may include near-eye displays that present left and right images to create the effect of three-dimensional view 802. In some embodiments, near-eye displays may use digital light processing (DLP), liquid crystal display (LCD), liquid crystal on silicon (LCoS), or light-emitting diode (LED). As another example, display system 810 may include a direct retinal projector that scans frames including left and right images, pixel by pixel, directly to the user's eyes via a reflective surface (e.g., reflective eyeglass lenses). To create a three-dimensional effect in view 802, objects at different depths or distances in the two images are shifted left or right as a function of the triangulation of distance, with nearer objects shifted more than more distant objects. Display system 810 may support any medium such as an optical waveguide, a hologram medium, an optical combiner, an optical reflector, or any combination thereof. In some embodiments, display system 810 may be transparent or translucent and be configured to become opaque selectively.

Controller 820 includes circuitry configured to facilitate operation of HMD 800. Accordingly, controller 820 may include one or more processors configured to execute program instructions to cause HMD 800 to perform various operations described herein such as those associated with applications 224 and 324. These processors may be CPUs configured to implement any suitable instruction set architecture and may be configured to execute instructions defined in that instruction set architecture. For example, in various embodiments controller 820 may include general-purpose or embedded processors implementing any of a variety of instruction set architectures (ISAs), such as ARM, x86, PowerPC, SPARC, RISC, or MIPS ISAs, or any other suitable ISA. In multiprocessor systems, each of the processors may commonly, but not necessarily, implement the same ISA. Controller 820 may employ any microarchitecture, including scalar, superscalar, pipelined, superpipelined, out of order, in order, speculative, non-speculative, etc., or combinations thereof. Controller 820 may include circuitry to implement microcoding techniques. Controller 820 may include one or more levels of caches, which may employ any size and any configuration (set associative, direct mapped, etc.).

In some embodiments, controller 820 may include a GPU, which may include any suitable graphics processing circuitry. Generally, a GPU may be configured to render objects to be displayed into a frame buffer (e.g., one that includes pixel data for an entire frame). A GPU may include one or more graphics processors that may execute graphics software to perform a part or all of the graphics operation, or hardware acceleration of certain graphics operations. In some embodiments, controller 820 may include one or more other components for processing and rendering video and/or images, for example image signal processors (ISPs), coder/decoders (codecs), etc. In some embodiments, controller 820 may be implemented as a system on a chip (SOC).

Memory 830 is a non-transitory computer readable medium configured to store data and program instructions executed by processors in controller 820 such as those facilitating the authentication techniques described herein. Memory 830 may include any type of volatile memory, such as dynamic random-access memory (DRAM), synchronous DRAM (SDRAM), double data rate (DDR, DDR2, DDR3, etc.) SDRAM (including mobile versions of the SDRAMs such as mDDR3, etc., or low power versions of the SDRAMs such as LPDDR2, etc.), RAMBUS DRAM (RDRAM), static RAM (SRAM), etc. Memory 830 may also be any type of non-volatile memory such as NAND flash memory, NOR flash memory, nano RAM (NRAM), magneto-resistive RAM (MRAM), phase change RAM (PRAM), Racetrack memory, Memristor memory, etc. In some embodiments, one or more memory devices may be coupled onto a circuit board to form memory modules such as single inline memory modules (SIMMs), dual inline memory modules (DIMMs), etc. Alternatively, the devices may be mounted with an integrated circuit implementing system in a chip-on-chip configuration, a package-on-package configuration, or a multi-chip module configuration.

Network interface 840, in various embodiments, includes one or more interfaces configured to communicate with external entities. Network interface 840 may support any suitable wireless technology such as Wi-Fi®, Bluetooth®, Long-Term Evolution™, etc. or any suitable wired technology such as Ethernet, Fibre Channel, Universal Serial Bus™ (USB) etc. In some embodiments, network interface 840 may implement a proprietary wireless communications technology (e.g., 90 gigahertz (GHz) wireless technology) that provides a highly directional wireless connection. In some embodiments, HMD 800 may select between different available network interfaces based on connectivity of the interfaces as well as the particular user experience being delivered by HMD 800. For example, if a particular user experience requires a high amount of bandwidth, HMD 800 may select a radio supporting the proprietary wireless technology when communicating wirelessly to stream higher quality content. If, however, a user is merely a lower-quality movie, Wi-Fi® may be sufficient and selected by HMD 800. In some embodiments, HMD 800 may use compression to communicate in instances, for example, in which bandwidth is limited.

The present technology may gather and use data from various sources to facilitate a secure authentication of a user across multiple devices. This data, in some instances, may include personal information data that uniquely identifies or may be used to locate or contact a specific individual. This personal information data may include location-based data, demographic data, telephone numbers, email addresses, social media account names, home or work addresses, data or records associated with a user's health or fitness level (e.g., information associated with vital signs, medication, exercise, and the like), date of birth, or other personal or identifying information.

It is recognized that, in some instances, such personal information data may be used to benefit users. For example, the personal information data may be used to improve the security of the authentication scheme to ensure that it is not easily circumvented.

It is contemplated that the collection, disclosure, transfer, analysis, storage, or other use of personal information data should comply with well-established privacy policies or practices. Privacy policies and practices that are generally recognized as meeting or exceeding industry or governmental requirements for maintaining personal information data private and secure should be implemented and consistently used. These policies should be easily accessible and updated as the collection or use of the personal information data changes. Personal information data should be collected for legitimate and reasonable uses and not shared or sold outside of those legitimate uses. The collection or sharing should occur after receipt of the user's informed consent. Additional steps to safeguard and secure access to personal information data and to ensure that others with access to the personal information data adhere to their privacy policies and procedures should be considered. An evaluation by third parties to certify adherence to well-established privacy policies and practices may be performed. Policies and practices should be tailored to the particular types of personal information data being collected or accessed and adapted to applicable laws and standards, including jurisdiction-specific considerations. For example, the collection of or access to certain health data in the US may be governed by federal or state laws, such as the Health Insurance Portability and Accountability Act (HIPAA); whereas the collection of or access to the same health data may be subject to other regulations and policies in other countries. As such, different privacy practices should be implemented for different types of personal information data in each country.

It is contemplated that, in some instances, users may selectively prevent the use of, or access to, personal information data. Hardware or software features may be provided to prevent or block access to personal information data. For example, in the case of user authentication across multiple devices, the present technology may be configured to allow users to “opt in” or “opt out” of the collection of personal information data during registration or anytime thereafter. In another example, users can select not to provide camera access for user authentication. In yet another example, users can select to limit the length of time camera access is maintained or entirely prohibit the camera use for user authentication across multiple devices. The present technology may also provide notifications relating to the access or use of personal information data. For example, a first notification may be provided in response to a user downloading an app that may access the user's personal information data and a second notification may be provided to remind the user just before the app accesses the personal information data.

Personal information data should be managed and handled to reduce the risk of unintentional or unauthorized access or use. Risk can be reduced by limiting the collection of data and deleting the data once it is no longer needed. When applicable, data de-identification may be used to protect a user's privacy. For example, de-identification may be performed by removing specific identifiers, controlling the specificity or amount of data stored (e.g., collecting home location data at a city level instead of at an address level), controlling how data is stored (e.g., aggregate data across multiple users), or by using other techniques.

Although the present technology may broadly include the use of personal information data, it may be implemented without accessing such personal information data. In other words, the present technology may not be rendered inoperable due to the lack of some or all of such personal information data. For example, authentication of a user across multiple devices based on non-personal information data, a reduced amount of personal information data, or publicly available information.

The present disclosure includes references to “an embodiment” or groups of “embodiments” (e.g., “some embodiments” or “various embodiments”). Embodiments are different implementations or instances of the disclosed concepts. References to “an embodiment,” “one embodiment,” “a particular embodiment,” and the like do not necessarily refer to the same embodiment. A large number of possible embodiments are contemplated, including those specifically disclosed, as well as modifications or alternatives that fall within the spirit or scope of the disclosure.

This disclosure may discuss potential advantages that may arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more of the disclosed advantages. Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages often depends on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Accordingly, while the appended dependent claims may be drafted such that each depends on a single other claim, additional dependencies are also contemplated. Any combinations of features in the dependent that are consistent with this disclosure are contemplated and may be claimed in this or another application. In short, combinations are not limited to those specifically enumerated in the appended claims.

Where appropriate, it is also contemplated that claims drafted in one format or statutory type (e.g., apparatus) are intended to support corresponding claims of another format or statutory type (e.g., method).

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to a singular form of an item (i.e., a noun or noun phrase preceded by “a,” “an,” or “the”) are, unless context clearly dictates otherwise, intended to mean “one or more.” Reference to “an item” in a claim thus does not, without accompanying context, preclude additional instances of the item. A “plurality” of items refers to a set of two or more of the items.

The word “may” is used herein in a permissive sense (i.e., having the potential to, being able to) and not in a mandatory sense (i.e., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” and thus covers 1) x but not y, 2) y but not x, and 3) both x and y. On the other hand, a phrase such as “either x or y, but not both” makes clear that “or” is being used in the exclusive sense.

A recitation of “w, x, y, or z, or any combination thereof” or “at least one of . . . w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of . . . w, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure. Unless context provides otherwise, different labels used for a feature (e.g., “first circuit,” “second circuit,” “particular circuit,” “given circuit,” etc.) refer to different instances of the feature. Additionally, the labels “first,” “second,” and “third” when applied to a feature do not imply any type of ordering (e.g., spatial, temporal, logical, etc.), unless stated otherwise.

The phrase “based on” or is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors, or may be in response to the specified factors as well as other, unspecified factors. Consider the phrase “perform A in response to B.” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to.” Similarly, the phrase “in response to” is synonymous with the phrase “at least in part in response to.”

Within this disclosure, different entities (which may variously be referred to as “units,” “circuits,” other components, etc.) may be described or claimed as “configured” to perform one or more tasks or operations. This formulation— [entity] configured to [perform one or more tasks]—is used herein to refer to structure (i.e., something physical). More specifically, this formulation is used to indicate that this structure is arranged to perform the one or more tasks during operation. A structure can be said to be “configured to” perform some task even if the structure is not currently being operated. Thus, an entity described or recited as being “configured to” perform some task refers to something physical, such as a device, circuit, a system having a processor unit and a memory storing program instructions executable to implement the task, etc. This phrase is not used herein to refer to something intangible.

In some cases, various units/circuits/components may be described herein as performing a set of tasks or operations. It is understood that those entities are “configured to” perform those tasks/operations, even if not specifically noted.

The term “configured to” is not intended to mean “configurable to.” An unprogrammed FPGA, for example, would not be considered to be “configured to” perform a particular function. This unprogrammed FPGA may be “configurable to” perform that function, however. After appropriate programming, the FPGA may then be said to be “configured to” perform the particular function.

For purposes of U.S. patent applications based on this disclosure, reciting in a claim that a structure is “configured to” perform one or more tasks is expressly intended not to invoke 35 U.S.C. § 112 (f) for that claim element. Should Applicant wish to invoke Section 112 (f) during prosecution of a U.S. patent application based on this disclosure, it will recite claim elements using the “means for” [performing a function] construct.

Different “circuits” may be described in this disclosure. These circuits or “circuitry” constitute hardware that includes various types of circuit elements, such as combinatorial logic, clocked storage devices (e.g., flip-flops, registers, latches, etc.), finite state machines, memory (e.g., random-access memory, embedded dynamic random-access memory), programmable logic arrays, and so on. Circuitry may be custom designed, or taken from standard libraries. In various implementations, circuitry can, as appropriate, include digital components, analog components, or a combination of both. Certain types of circuits may be commonly referred to as “units” (e.g., a decode unit, an arithmetic logic unit (ALU), functional unit, memory management unit (MMU), etc.). Such units also refer to circuits or circuitry.

The disclosed circuits/units/components and other elements illustrated in the drawings and described herein thus include hardware elements such as those described in the preceding paragraph. In many instances, the internal arrangement of hardware elements within a particular circuit may be specified by describing the function of that circuit. For example, a particular “decode unit” may be described as performing the function of “processing an opcode of an instruction and routing that instruction to one or more of a plurality of functional units,” which means that the decode unit is “configured to” perform this function. This specification of function is sufficient, to those skilled in the computer arts, to connote a set of possible structures for the circuit.

What is claimed is:

1. A non-transitory computer readable medium having program instructions stored therein that are executable by a first device to cause the first device to perform operations, comprising:
storing, by an authentication system of the first device, an identity of a user of the first device;
detecting, by the authentication system, a visual indication presented on a display of a second device in response to a successful biometric authentication of a user of the second device; and
determining, by the authentication system and based on the visual indication, that the authenticated user of the second device corresponds to the identity of the user of the first device.

2. The computer readable medium of claim 1, wherein the operations further comprise:
determining, by the authentication system, an identity of the authenticated user encoded in the visual indication.

3. The computer readable medium of claim 1, wherein the operations further comprise:
determining, by the authentication system, a cryptographic key encoded in the visual indication; and
establishing, by the authentication system, a secure communication with the second device using the cryptographic key.

4. The computer readable medium of claim 1, wherein the operations further comprise:
determining, by the authentication system, a type of authentication encoded in the visual indication, wherein type includes one of capturing an iris of the user, a retina of the user, a facial structure of the user, or a fingerprint of the user.

5. The computer readable medium of claim 1, wherein the operations further comprise:
validating, by the authentication system, the visual indication including determining that the visual indication is dynamic such that the visual indication changes while it is presented.

6. The computer readable medium of claim 1, wherein the operations further comprise:
determining, by the authentication system and from the visual indication, a user account associated with the second device;
comparing, by the authentication system, a user account associated with the first device to the user account associated with the second device; and
based on the comparing, determining, by the authentication system, that the user account associated with the first device corresponds to the user account associated with the second device.

7. The computer readable medium of claim 1, wherein the visual indication is unique to a given exchange between the first device and the second device.

8. The computer readable medium of claim 1, wherein the operations further comprise:
based on the determining, permitting, by the authentication system, the user to log into the first device.

9. The computer readable medium of claim 1, wherein the operations further comprise:
based on the determining, permitting, by the authentication system, communication of a user credential from the first device to an external system.

10. The computer readable medium of claim 1, operations further comprise:
capturing, by a camera of the first device, the visual indication on a forward-facing display on the second device.

11. A first device, comprising:
a biosensor configured to collect biometric data from a biometric of a user; and
an authentication system configured to:
attempt to perform a user authentication based on the biometric of the user;
in response to determining that the biometric of the user is obstructed during collection of the biometric data, send a request to a second device configured to perform a biometric authentication of the user, wherein the request asks for a confirmation that the user has been authenticated; and
perform the user authentication without the collected biometric data based on the received confirmation.

12. The first device of claim 11, wherein the authentication system is further configured to:
send the request over a first communication medium; and
receive the confirmation over a second, different communication medium.

13. The first device of claim 11, wherein the confirmation is a visual indication and wherein the sending of the request causes the visual indication to be displayed by the second device.

14. The first device of claim 11, wherein the confirmation encodes an identity of the authenticated user.

15. The first device of claim 11, wherein the confirmation is an audio indication and wherein the sending of the request causes the audio indication to be performed by the second device.

16. The first device of claim 11, wherein the request specifies a user account associated with the device, and wherein the request causes the second device to:
compare the user account to a user account associated with the second device; and
provide the confirmation in response to the comparison indicating a match.

17. A first device, comprising:
a biosensor configured to collect biometric data from a biometric of a user; and
an authentication system configured to:
perform a user authentication based on the collected biometric data;
receive a request from a second device, wherein the request asks for a confirmation that a user has been authenticated; and
in response to the user authentication being successful, display a visual indication on a display.

18. The first device of claim 17, further comprising:
a display with a lenticular lens, wherein the display is configured to:
in response to the user authentication being successful, display a plurality of visual indications including a first visual indication visible from a first viewing angle and a second visual indication visible from a second viewing angle.

19. The first device of claim 17, wherein the visual indication encodes a username associated with the user.

20. The first device of claim 17, wherein the request specifies a user account associated with the second device, and wherein the authentication system is configured to:
compare the user account to a user account associated with the first device; and
display the visual indication in response to the comparison indicating a match.
